(19) United States
(12) Patent Application Publication
(10) Pub. No.: US 2015/0287268 A1
(43) Pub. Date: Oct. 8, 2015

(54) MULTI-REEL GAME DEVICE AND METHOD OF CONTROLLING SAME

(71) Applicant: NEXCADE CO., LTD., Guro-gu Seoul (KR)

(72) Inventor: Yong Hwan Kim, Gyeonggi-do (KR)

(21) Appl. No.: 14/436,900

(22) PCT Filed: Oct. 17, 2013
(86) PCT No.: PCT/KR2013/009269

§ 371 Date: Apr. 20, 2015

(30) Foreign Application Priority Data
Oct. 19, 2012 (KR) 10-2012-0116519
Apr. 2, 2013 (KR) 10-2013-0035683

(51) Int. Cl. G07F 17/32; G07F 17/34

(52) U.S. Cl. CPC G07F 17/3213; G07F 17/34

(57) ABSTRACT

Disclosed are a multi-reel game device and a method of controlling the same. The device of the present invention comprises three or more reel display parts arranged on a table for players to play a game simultaneously, and a control unit for driving the reels of the reel display parts simultaneously when the players have selected a betting amount, pressed the start button, or completed the betting time so as to allot a winning score according to a dividend rate to a player whose selected betting line shows at least a given number of the same symbols in the reel display part of the stopped reel, whereby a single table can provide a game connecting the players, thus making the game more interesting.

### TECHNICAL FIELD

The present invention generally relates to a reel game device. More particularly, the present invention relates to a multi-reel game device and a method of controlling the device to enable several players to play a game simultaneously using individual reel game devices on a table.

### BACKGROUND ART

A reel game device is divided into a mechanical reel game device and an electronic reel game device. The mechanical reel game device spins or stops a circular reel, in which multiple characters are arranged in a line, using a drive motor, and shows the stopped circular reel images on a screen. In case of the electronic reel game device, multiple characters are randomly displayed on a display screen such as a monitor, and the like.

This type of existing game device is disclosed in Korean Patent Application Publication No. 10-2007-0043190 (Control method of a game machine).

Referring to FIGS. 1 and 2, a reel game device is configured to include: a money insertion detection unit 11 for detecting insertion of commodity money such as coins or bills, or insertion of token money such as medals or scrip money; a central processing unit 12 for automatically controlling the operation of the game device by receiving a money insertion signal from the money insertion detection unit 11; an input unit 13 for controlling the operation of the central processing unit 12; a display 14 controlled by the central processing unit 12 for displaying reels; and a gift dispenser 15 controlled by the central processing unit 12 for dispensing a gift.

The input unit 13, as illustrated in FIG. 2, is configured to include a betting switch for inputting a betting number, a start switch for inputting a game start signal, and a gift dispensation switch 11a for inputting a gift dispensation signal. Well-known components such as cathode-ray tube monitors, PDPs, and LCDs, in which game images and text including scores can be displayed on a screen, are used for the display 14.

A lamp lighting unit 16 is configured to be lit or to blink according to the game progress status, in order to visually express the progress of the game.

The central processing unit 12 receives an output signal from the money insertion detection unit 11 and the input unit 13, performs a reel game, and automatically controls the operations of the display 14 and the gift dispenser 15.

This kind of the existing reel game device only allows for one player. Therefore, a multi-reel game device is required in order that several players may enjoy more interesting and varied game play.

To form a multi-reel game device that enables multiple players to play a game at the same time, a plurality of single-reel game devices should be installed and a device for sharing a game result is required.

To partially solve the above problems, previously disclosed is a device in which one player or two players can play a game with one reel display part, or a device in which two players can play a game by arranging two reel display parts on one monitor.

First, in the case where two players play a game using one reel display part, because a score window or a run button is configured to be simply expanded on the same monitor, the two players may not feel like they are playing the game independently. Furthermore, the device is inconvenient for use in a multiplayer situation where there are more than two players.

Also, a game device in which two reel display parts are arranged on one monitor allows for two players, but a plurality of the game devices should be installed to allow three or more players.

Also, multiple game devices can be arranged by being interconnected, but in this case different reel display parts are separately operated and displayed, thus the results of the game can be different. Accordingly, the players may not be satisfied with the results.

Additionally, an operator who manages reel game devices can obtain a profit depending on the number of users by effectively managing the devices. In this case, as a game room is crowded with reel game users at particular times, it is difficult to accommodate the users even if all the reel game devices are fully operated. Also, there exist spatial constraints of the game room and some burden of investment cost.

Consequently, required is a reel game device installed in the same place but capable of selectively operating as a game device for three or more players.

### DISCLOSURE

### Technical Problem

To solve the above problem, an object of the present invention is to provide a multi-reel game device and a method of controlling the device that enable three or more players to play a reel game at the same time.

Another object of the present invention is to provide a multi-reel game device and a method of controlling the device that enable three or more players to play a game at a table simultaneously.

A further object of the present invention is to provide a multi-reel game device and a method of controlling the device that arrange reel display parts for individual players on a table and display the same symbols on the reel display parts by simultaneously operating the reel display parts.

Yet another object of the present invention is to provide a multi-reel game device and a method of controlling the device such that three or more single-reel game devices can be connected using a network.

Still another object of the present invention is to provide a multi-reel game device and a method of controlling the device that connect three or more single-reel game devices by a network and simultaneously operate the devices to display the same symbols on the reel display parts.

Still another object of the present invention is to provide a multi-reel game device and a method of controlling the device in which a Joker symbol is included in reel symbols and the Joker symbol is replaced with another symbol to raise a score when the Joker symbol is included in the displayed reel symbols.

Still another object of the present invention is to provide a multi-reel game device and a method of controlling the device in which a bonus game or a jackpot game is played or a jackpot score can be displayed when a reel symbol displayed as a result of a game corresponds to a predetermined condition.

### Technical Solution

In order to accomplish the above objects, a multi-reel game device according to an embodiment of the present invention has reel display parts for three or more players at a table, determines one or more betting lines, and enables the players to simultaneously play a game using the reel display parts assigned to the individual players, wherein the reel display parts each have reels that are formed as an array with three or more rows and columns, the reels each have one or more symbols, and the betting line includes each column of the reels to be displayed on the reel display part.

The multi-reel game device includes a control unit, which simultaneously spins the reels of the reel display parts when the players have selected a betting amount, when a start button has been operated, or when a betting time has finished; simultaneously stops the reels after a predetermined time has passed; and allots a winning score according to a dividend rate when, among symbols of the stopped reels of the reel display part, the same symbols included in a betting line that a relevant player has selected are equal to or greater than a predetermined number.

The reel display parts for the individual players are simultaneously displayed on a monitor. Around edges of the monitor, three or more of the reel display parts are assigned to players, respectively. Also, an input unit for selecting a betting line and a betting amount is arranged in each of the reel display parts.

The reel display parts separately display people on a betting waiting list and people who have finished betting within the betting time, among players participating in the game, and the control unit displays the winning score for each of the players on the reel display parts around the edges of the monitor.

The reel display parts may be displayed on a central monitor disposed at the center and on additional monitors for the individual players.

The multi-reel game device further includes a timer for displaying a betting time; and start buttons, for enabling each of the players to start a game, and the control unit determines that the players have completed the betting when the betting time of the timer has finished, when the players have completed their betting within the betting time of the timer, or when the players have input the start buttons.

In order to accomplish the above objects, a multi-reel game device according to another embodiment of the present invention includes: a single-reel game device, which displays three or more rows of reels and three or more columns of reels, determines one or more betting lines, and allows a game by betting a betting amount for the selected betting line, wherein each of the reels has a reel symbol and the betting line includes each column of the reels displayed on the reel display part; and a main control unit, which connects three or more of the single-reel game devices by a network, for allowing playing a game while communicating with the devices, wherein the main control unit simultaneously spins the reels of the single-reel game devices when a betting amount of the single-reel game devices has been selected, when a start button has been operated, or when a betting time has finished; simultaneously stops the reels after a predetermined time has passed; and allots a winning score according to a dividend rate when, among symbols of the stopped reels of the reel display part, the same symbols included in a betting line that a relevant player has selected are equal to or greater than a predetermined number.

The multi-reel game device further includes a billboard monitor that is electrically connected with the main control unit, and the main control unit may display a remaining betting time or a progress of the remaining betting time, as a graph on monitors of the single-reel game devices or on the billboard monitor.

In order to accomplish the above objects, a method of controlling a multi-reel game device according to a further embodiment of the present invention is configured to arrange reel display parts for three or more players at a table, to determine one or more betting lines, and to enable the players to simultaneously play a game using the reel display parts assigned to the individual players, wherein the reel display parts each have reels that are formed as an array with three or more rows and columns, the reels each have one or more symbols, and the betting line includes each column of the reels to be displayed on the reel display part. The method of controlling the multi-reel game device may include: (a) displaying a betting time in a timer; (b) a betting step, by each of the players, for selecting a betting line through an input unit, and for selecting a betting amount for the betting line; (c) simultaneously spinning, by a control unit, the reels of the reel display parts when the betting step has been completed within the betting time of the timer, and simultaneously stopping, by the control unit, the reels of the reel display parts after a predetermined time has passed; (d) determining whether among symbols of the stopped reels of the reel display part, the same symbols included in the betting line that a relevant player has selected are equal to or greater than a predetermined number; and (e) allotting, by the control unit, a winning score for each of the players according to a dividend rate when it is determined at step (d) that the same symbols included in the betting line are equal to or greater than the predetermined number.

Step (b) may be concretely implemented by the following steps: (b-1) selecting, by each of the players, a betting line through an input unit; (b-2) displaying the selected betting line on the relevant reel display part or a display part disposed in the input unit; and (b-3) selecting a betting amount for the betting line and displaying the betting amount.

Step (c) includes: (c-1) determining by the control unit, that any one is satisfied among whether the betting time of the timer has finished, whether all the players participating in the game have selected the betting line and the betting amount, or whether the start button has been operated, (c-2) simultaneously spinning the reels of the reel display parts when any one is satisfied at step (c-1); and (c-3) simultaneously stopping, by the control unit, the spinning reel display parts after a predetermined time has passed.

Step (e) is configured to include: (e-1) allotting a winning score according to a dividend rate when among symbols of the stopped reels of each of the reel display parts, three or more of the same symbols are included in the betting line that the relevant player has selected; (e-2) displaying a Joker symbol or changing the Joker symbol to raise a winning score of the betting line, and allotting the winning score according to the corresponding dividend rate, when among the symbols of the stopped reels of each of the reel display parts, one or more of the Joker symbols are included in the betting line selected by the relevant player; and (e-3) performing any one selected from among the play of a bonus game, the play of a jackpot game, or the allotment of a jackpot score when the betting line selected by the relevant player includes three or more of the same symbols and when the symbols of the stopped reels of each of the reel display parts are the same as the symbols set to lead to the bonus game, set to lead to the jackpot game, or set to allot the jackpot score.

A method of controlling a multi-reel device according to yet another embodiment of the present invention arranges a single-reel game device, a main control unit that connects three or more of the single-reel game devices by a network for allowing playing a game while communicating with the single-reel game devices, and a billboard monitor that is electrically connected with the main control device, wherein the single-reel game device has a reel display part formed as an array with three or more rows and columns, determines one or more betting lines, and allows playing a game by betting a betting amount for the selected line, the reels each having one or more symbols, and the betting line including each column of the reels to be displayed on the reel display part. The method of controlling the multi-reel device may include: (a) displaying a betting time in the single-reel game device or on the billboard monitor; (b) selecting a betting line in each of the single-reel game devices, and selecting a betting amount for the betting line; (c) simultaneously spinning, by the main control unit, the reels of the single-reel game devices when the betting amount has been selected by the single-reel game devices, when a start button has been operated, or when a betting time has finished; and simultaneously stopping, by the main control unit, the reel display parts after a predetermined time has passed; (d) determining whether among symbols of the stopped reels of each of the reel display part, the same symbols included in the betting line that a relevant player has selected are equal to or greater than a predetermined number; (e) allotting, by an individual reel control unit, a winning score according to a dividend rate when the same symbols included in the betting line are equal to or greater than the predetermined number at step (d).

A method for controlling a multi-reel game device according to still another embodiment of the present invention arranges a central monitor disposed at the center and one or more additional monitors for individual players. On the monitors for the individual players, a reel display part formed as an array with three or more rows and columns of reels having a symbol is displayed. The method determines one or more betting lines that include each column of the reels to be displayed on the reel display part, and allows playing a game using the reel display parts assigned to the individual players. The method of controlling the multi-reel device may include: (a) a betting step, by each of the players, for selecting a betting line through an input unit, and for selecting a betting amount for the betting line; (b) simultaneously spinning, by a control unit, the reels of the reel display parts when the players have completed the betting step, and simultaneously stopping, by the control unit, the reels of the reel display parts after a predetermined time has passed; (c) determining whether among symbols of the stopped reels of the reel display part, the same symbols included in the betting line that a relevant player has selected are equal to or greater than a predetermined number; and (d) allotting, by the control unit, a winning score for each of the players according to a dividend rate when it is determined at step (c) that the same symbols included in the betting line are equal to or greater than the predetermined number.

A multi-reel game device according to still another embodiment of the present invention separately arranges reel display parts that have reels formed as an array with three or more rows and columns, for three or more players on one monitor on a table; arranges a jackpot display part on one side of the table; and enables each of the players to play an individual game by selecting one or more lines among predetermined betting lines that include each column of the reels displayed on each of the reel display parts, the reels each having one or more symbols. The multi-reel game device includes a control unit, which spins a reel display part either when the predetermined betting line and betting amount are selected in the corresponding reel display part or when a start button has been operated; stops the reel display part after a predetermined time has passed; and allots a winning score according to a dividend rate when among symbols of the stopped reels of the reel display part, the same symbols included in the betting line that a relevant player has selected are equal to or greater than a predetermined number.

A multi-reel game device according to still another embodiment of the present invention, which has reel display parts for three or more players each on a table, determines one or more betting lines, and enables the players to simultaneously play a game using the reel display parts assigned to the individual players, wherein the reel display parts each have reels that are formed as an array with three or more rows and columns, the reels each have one or more symbols, and the betting line includes each column of the reels to be displayed on the reel display part, may include: a single game selection button, arranged in each of the reel display parts; and a control unit, which simultaneously spins the reels of the reel display parts except for the reel display parts in which the single game selection button is input, when the players have selected a betting amount, when a start button has been operated, or when a betting time has finished; simultaneously stops the reels after a predetermined time has passed; and allots a winning score according to a dividend rate when among symbols of the stopped reels of the reel display part, the same symbols included in the betting line that a relevant player has selected are equal to or greater than a predetermined number.

A multi-reel game device according to still another embodiment of the present invention, which has reel display parts for three or more players on a table, determines one or more betting lines, and enables the players to play a game using the reel display parts assigned to the individual players, wherein the reel display parts each have reels that are formed as an array with three or more rows and columns, the reels each have one or more symbols, and the betting line includes each column of the reels to be displayed on the reel display part, may include: an input unit, arranged in each of the reel display parts, for selecting a betting amount and the betting line; and a control unit, which spins the reels of the reel display parts assigned to the individual players when the players have selected a betting amount, when a start button has been operated, or when a betting time has finished; stops the reels after a predetermined time has passed; and allots a winning score according to a dividend rate when among symbols of the stopped reels of the reel display part, the same symbols included in a betting line that a relevant player has selected are equal to or greater than a predetermined number.

### Advantageous Effects

A multi-reel game device and a method of controlling the device according to one embodiment of the present invention have an effect to enhance interested in and enjoyment of a game because three or more players at one table can play the game because multi-reel game devices are interconnected or they can independently enjoy the reel games.

Also, in a multi-reel game device and a method of controlling the device according to one embodiment of the present invention, the device can be installed in a small room but allows multiple players to enjoy a game at the same time. Therefore, a game room can be more effectively managed.

Also, as the present invention additionally provides a bonus game and a jackpot game, a player can enjoy various games by running a single game.

Also, as the present invention can display a Joker symbol or replace the Joker symbol with another symbol in the displayed reel symbols to raise a score, players may find the game more exciting.

Also, according to the present invention, as existing single-reel game devices can be connected by a network, multiple players can play independent games or they can play a game in a multiplayer competitive manner.

Also, according to the present invention, as multiple reel display parts can be displayed on one monitor, players can easily check the game progress status of competitors and competition between players can be induced, thus increasing the interest of the game. Additionally, a manager can manage a game room at a low cost, and spatial requirements can be reduced.

Also, because the present invention enables multiple players each to play a reel game independently or play a reel game in a multiplayer manner at a single table, the players can check the game progress status, thus increasing the interest of the game. Additionally, because the multi-reel game device has reduced spatial requirements, an operator can install the device in a small space, therefore it is economical.

### DESCRIPTION OF DRAWINGS

FIG. 1 is a block diagram of existing single-reel game device;

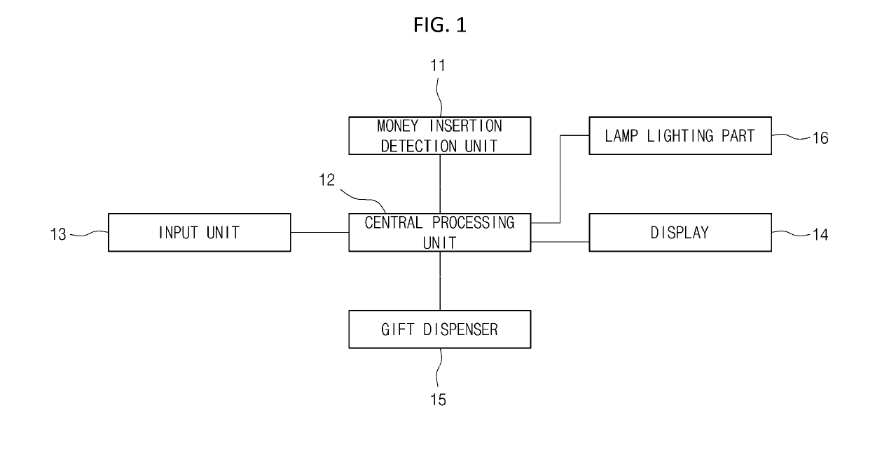

FIG. 2 is a perspective view of existing reel game device;

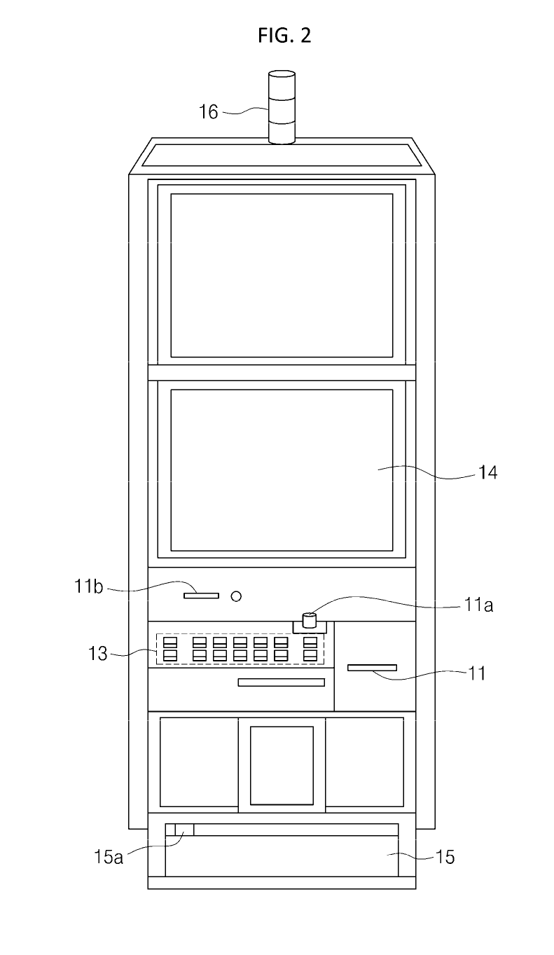

FIG. 3 is a main configuration diagram of a multi-reel game device according to an embodiment of the present invention;

FIG. 4 is a plan view of a multi-reel game device according to an embodiment of the present invention;

FIG. 5 is a front view of a multi-reel game device of FIG. 4;

FIG. 6 is a view illustrating an example of a setting line of a reel display part of the present invention;

FIG. 7 is an exemplary view of a setting line displayed in a reel display part when a player selects five betting lines;

FIG. 8 is a view illustrating an example in which a player wins when the player selects LINE 7;

FIG. 9 is a flow diagram illustrating a method of controlling a multi-reel game device according to an embodiment of the present invention;

FIG. 10 is a main configuration diagram of a multi-reel game device according to another embodiment of the present invention;

FIG. 11 is a view illustrating an example in which a reel display part is differently configured in the plan view of the multi-reel game device of FIG. 4;

FIG. 12 is a plan view of a multi-reel game device according to a further embodiment of the present invention; and

FIG. 13 is a view illustrating an example of an input unit.

### BEST MODE

All terms or words used in the specification and claims have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the present specification, it should be understood that the terms such as “include” or “have” are merely intended to indicate that components are present, and are not intended to exclude a possibility that one or more other components, will be present or added. Also, in the specification, “unit”, “part”, “module”, “device”, “system”, or the like, means a unit for performing at least one function or operation, and can be implemented by hardware, software, and/or a combination thereof.

Hereinafter, exemplary embodiments of the present invention will be described in detail with reference to the accompanying drawings.

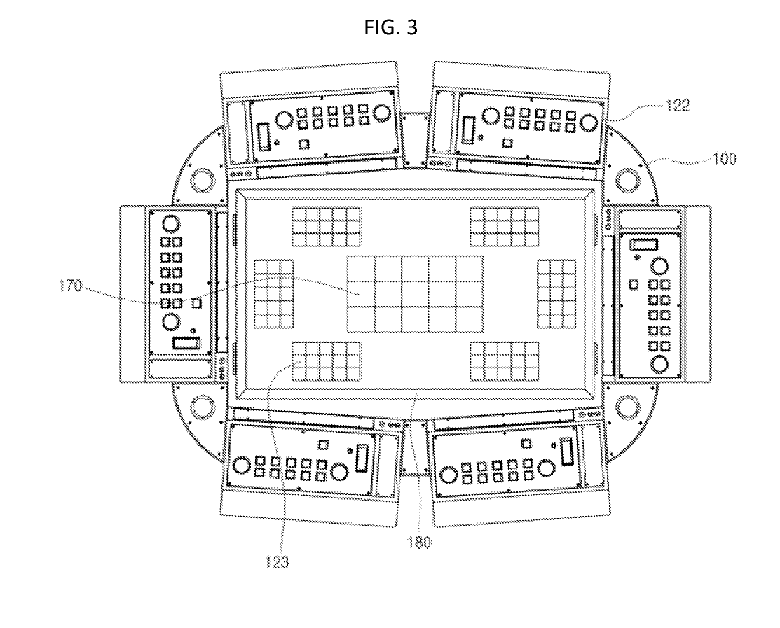

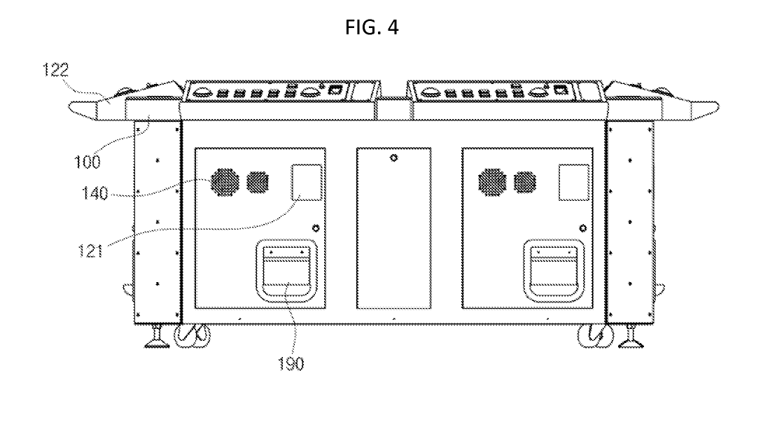

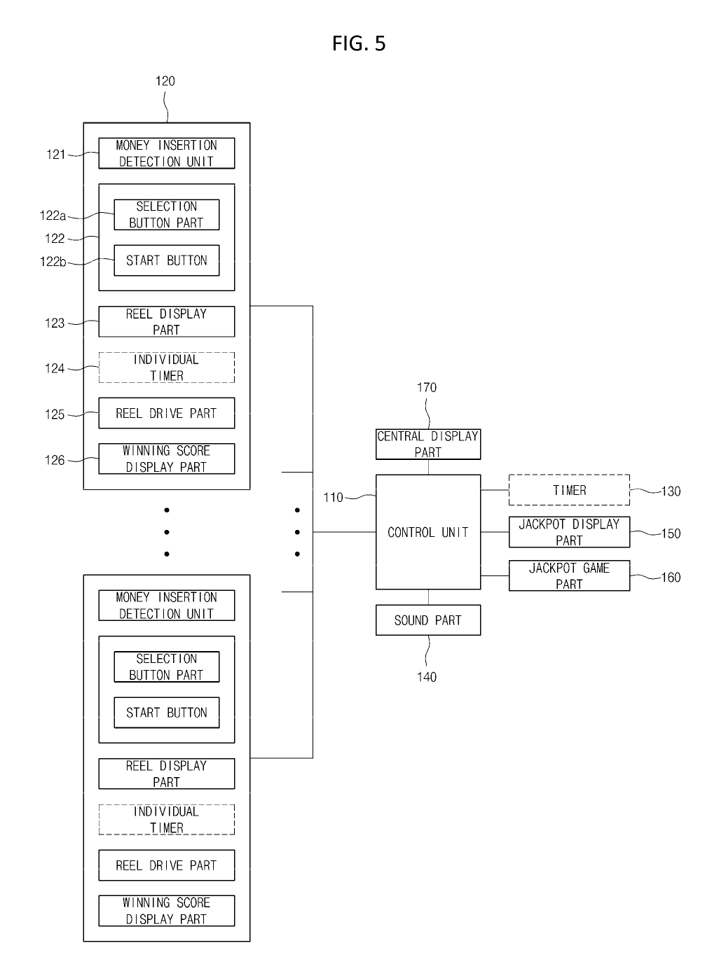

FIG. 3 is a main configuration diagram of a multi-reel game device according to an embodiment of the present invention; FIG. 4 is a plan view of a multi-reel game device according to an embodiment of the present invention; and FIG. 5 is a front view of the multi-reel game device of FIG. 4.

A multi-reel game device according to an embodiment of the present invention includes three or more individual reel game devices 120 that can execute an individual reel game, and a control unit 110 for controlling the three or more reel game devices 120, which are arranged on a table.

In the present invention, three or more of the individual reel game devices 120 and the control unit 110 for simultaneously controlling the devices are arranged to enable three or more players to play games at the same time.

To implement the above description, the individual reel game device 120 has three or more reel display parts 123 for three or more players on a table, wherein each of the reel display parts 123 has reels that display one or more symbols and that are formed as an array with three or more rows and columns. The control unit 110 sets one or more betting lines, wherein each of the betting lines includes each column of the reels that will be displayed on the reel display part 123; simultaneously spins the reels of the reel display parts 123 when the players have completed the betting and stops them; and allots winning scores according to a dividend rate.

More specifically, the multi-reel game device is configured to arrange three or more of the individual reel game devices 120, the individual reel game device 120 including a money insertion detection unit 121 for detecting insertion of money; an input unit 122; a reel display part 123 for displaying reels on which one or more symbols are displayed, in three or more rows and three or more columns; a reel drive part 125 for driving the reel; and a winning score display part 126 for displaying a winning score as the result of driving the reel.

The money insertion detection unit 110 uses a well-known sensor for detecting insertion of coins or medals through a coin slot, or a well-known note sensing device for detecting insertion of bills or scrip money through a paper money slot or a card reader.

The reel display part 123 can display 3×1 reels, 4×1 reels, 3×3 reels, 5×3 reels, 6×3 reels, and the like, but in the present invention, the case in which a reel display part having 3 rows and 5 columns is used will be described below.

As the reel symbols and the operation method of the reel display parts 123 are widely known to people skilled in the relevant field, the detailed descriptions are omitted.

The reel display part 123 can be displayed on a monitor 180 for three or more players each. The reel display part 123 can be assigned to each player by being arranged around the edges of the monitor, or by being arranged at the center and around the edges of the monitor.

In FIG. 4, referring to a plan view of the multi-reel game device according to an embodiment of the present invention, a central display part 170 is disposed at the center of a monitor and six reel display parts 123 for players are arranged around the edges of the monitor.

According to another configuration, the central display part 170 can be omitted.

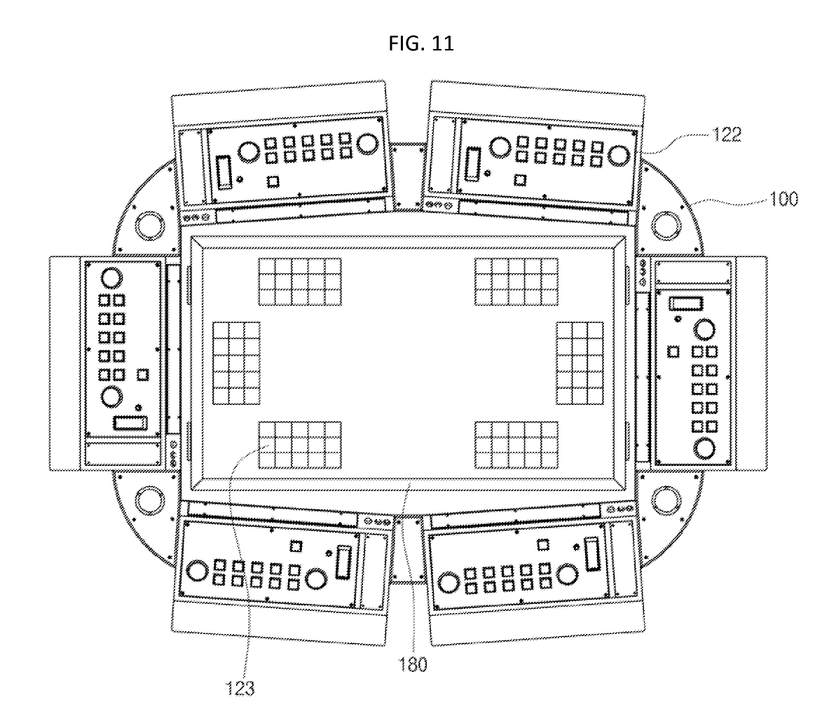

Referring to FIG. 11 that illustrates one example in which a reel display part is differently configured in the plan view of the multi-reel game device of FIG. 4, one monitor 180 is used, a central display part is omitted, and multiple reel display parts 123 for players each are arranged around the edges of the central monitor 180.

The central display part 170 can be provided for a case where several people at the same party enjoy a single multiplayer game together and they watch the central display part 170 displayed at the center rather than individual reel display parts 123. Therefore, the central display part 170 can be selected as needed.

The central display part 170 can be installed as a fundamental component, but can be displayed or turned off according to the selection of the user.

Also, besides the above description, the reel display parts can be displayed on a central monitor and monitors for players each, which are placed on a table.

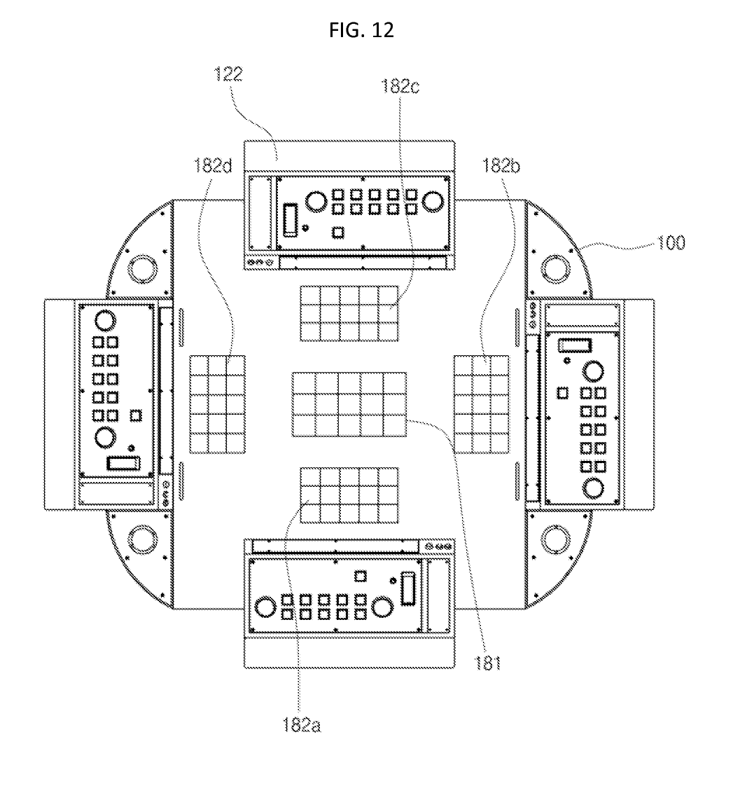

In FIG. 12, referring to a plan view of a multi-reel game device according to a further embodiment of the present invention, it is possible to arrange reel display parts 182a, 182b, 182c, and 182d that are formed as separated monitors for individual players on a table, and a central display part 181 as a different monitor at the center.

In other words, in the present invention, reel display parts are configured using different monitors on a table (with reference to FIG. 12), or reel display parts for individual players can be displayed on divided sections of a monitor (with reference to FIG. 4).

As described above, the central display part 181 can be installed or not, as needed.

Among players participating in a game, the reel display part 123 can separately display people on the betting waiting list and people who have finished their betting, so that the players participating in the game can check the game progress status of others.

Also, the reel display part 123 can display text or images that are necessary for a game. In the present embodiment, reels having 15 symbols (characters) are configured to form an array of 3*5 (length*width) and each of the reels is variably displayed by driving a reel drive part 125.

Buttons required for playing the game are installed in the input unit 122.

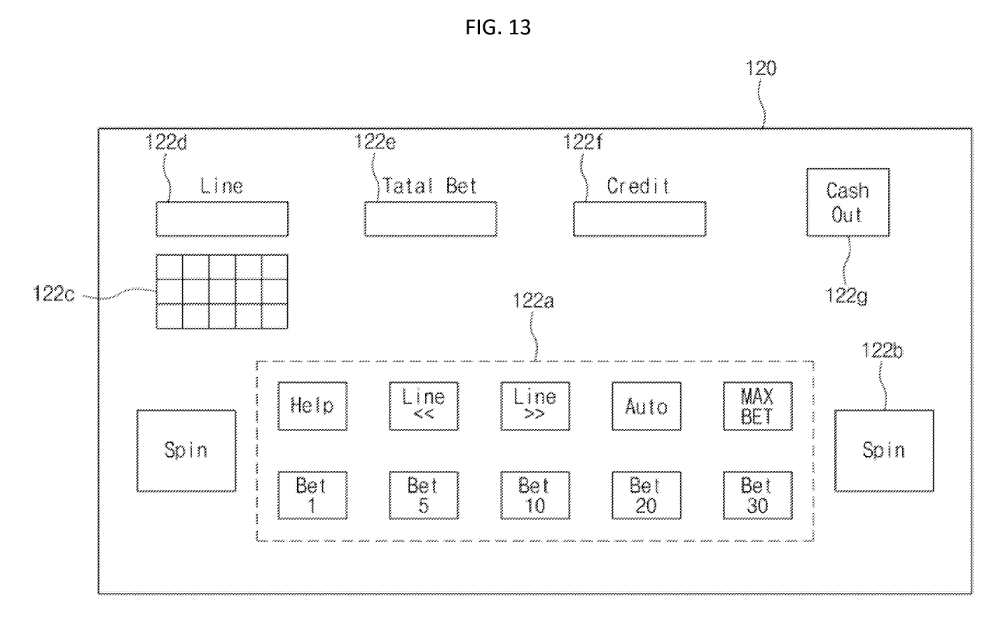

In FIG. 13, referring to a view illustrating an example of the input unit, the input unit may include: a selection button part 122a for selecting a betting line or a betting amount; a game start (Spin) button 122b; a line display part 122d for displaying the number of lines selected by a player; a betting display part 122e for displaying a total betting amount as credit, which is obtained by multiplying the betting amount by the number of lines selected by the player; a credit display part 122f for displaying credit owned by the player; and a coin or ticket dispenser (Cash Out) button 122g.

The selection button part 122a is configured to include: a service call (Help) button; line selection (Line [symbol] , Line [symbol] ) buttons for selecting a line among predetermined 25 lines; an auto selection (Auto) button for automatically setting a line; and a maximum betting (MAX BET) button for betting the maximum credit owned by a player, in other words, for betting the total credit displayed on the credit display part.

A betting line is variably selected by the line selection (Line [symbol] , Line [symbol] ) buttons. However, in the embodiment of the present invention, an example in which a reel display part is formed as an array of 3×5 and 25 selection lines are predetermined and stored in the system is described. In this case, each of the betting lines includes five reels, wherein five reels each is selected from each column of the array. A player can select a betting line among the stored 25 betting lines.

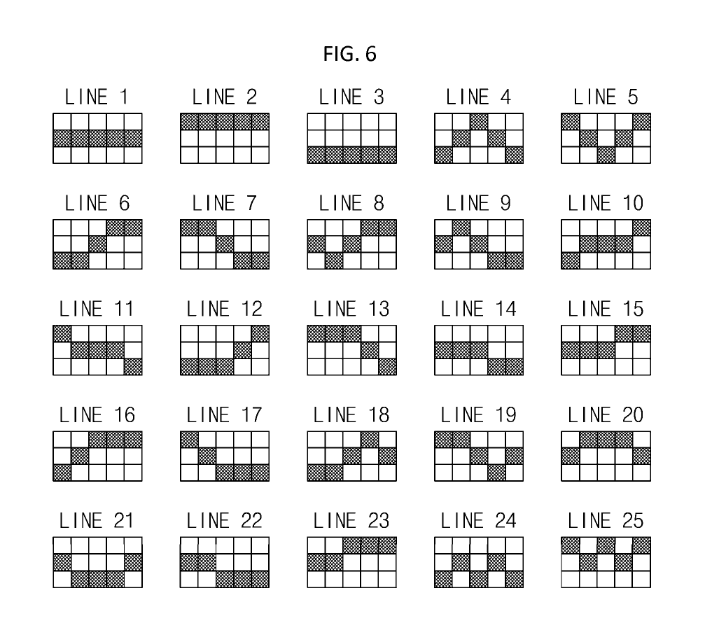

In FIG. 6, referring to a view illustrating an example of a setting line of the reel display part of the present invention, specific lines from LINE 1 to LINE 25 are determined and a player can select a line to bet on among them.

Accordingly, the player can select a line or a bundle of lines among the 25 lines. However, if the player uses the line selection (Line [symbol] , Line [symbol] ) buttons for quick selection, one line (LINE 1), three lines (LINE 1 to 3), five lines (LINE 1 to 5), nine lines (LINE 1 to 9), and all the lines (LINE 1 to 25) can be selected.

Also, a plurality of betting amount selection button (Bet 1 to Bet 30) are arranged in the selection button part 122a to easily select the betting amount. When the betting amount selection button is pressed, the amount corresponding to credit displayed on the button is bet.

On the other hand, an additional selected line display part 122c is included in the input unit 122 in order to display the shape of the line selected by the player. Accordingly, the line selected by the player can be easily checked.

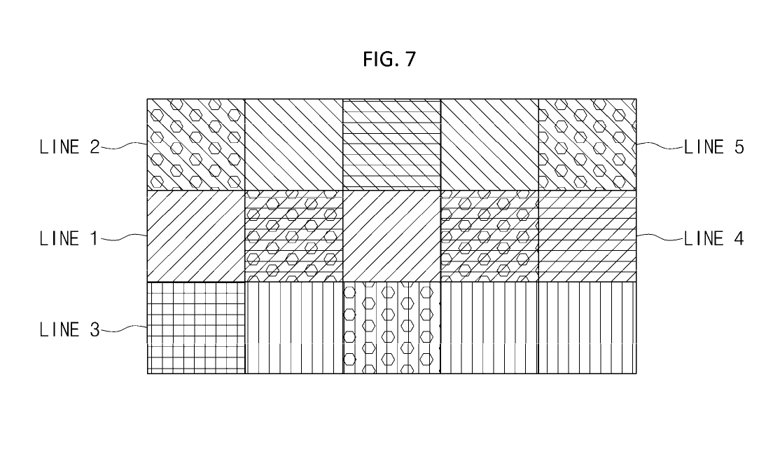

For example, in FIG. 7, referring to an exemplary view of a setting line displayed on a reel display part when a player selects 5 betting lines, the selected line is displayed on the corresponding reel display part 123 or on the selected line display part 122c.

In FIG. 7, LINE 1 is expressed by diagonal lines to the right; LINE 2 is expressed by diagonal lines to the left; LINE 3 is expressed by vertical diagonal pieces; LINE 4 is expressed by horizontal diagonal pieces; and LINE 5 is expressed by diamond shapes, so as to express the selected line in different colors.

As the setting of the lines, the selection method, and the expression of the lines can be configured as a matter of convenience, the detailed description is omitted.

Additionally, the input unit 122 may further include an automatic button. Accordingly, a player does not press the start button for every game but the game can be started automatically when a start condition is satisfied.

These functions can be added as a matter of convenience, therefore the detailed description is omitted.

An individual timer 124 is arranged in one side of the reel play part 123 or is arranged apart from the reel play part 123. The individual timer 124 displays a remaining betting time or the progress of the remaining betting time as a graph in order that a player can check the remaining betting time.

By control of a control unit 110, the reel drive part 125 spins the reels of the reel display part 123 at the same time and simultaneously stops them after a predetermined time has passed.

As a result of driving of the reel drive part 125, the reels of the reel display part 123 stop and display certain symbols. At this time, if more than a predetermined number of the same symbols are included in the betting line that has been selected by a player, the control unit 110 displays a winning score according to a dividend rate on the winning score display part 126.

In the present invention, when the line selected by the player includes three or more of the same symbols, it is determined a win.

When it is determined through the input unit 122 that players have completed the betting, the control unit 110 simultaneously controls the reel drive parts 125 for individual players to perform the following processes: simultaneously spinning reels of the reel display parts 123; simultaneously stopping the reels after a predetermined time has passed; allotting a winning score according to a dividend rate when in the symbols on the stopped reels of the reel display part 123 of each of the players, the betting line selected by the player includes the same symbols equal to or greater than a predetermined number; and displaying the winning score on the winning score display part 126.

The control unit 110 can determine that the betting has been completed when all the betting amounts are selected through the selection button part 122a of the input units 122 for individual players, when all the start buttons 122b are input, or when the betting time that is displayed on the individual timer 124 or on the timer 130 has finished. When the betting has been completed, the control unit 110 simultaneously drives the reel drive parts 125 for individual players to spin the reels of the reel display parts 123.

Additionally, the present invention may further include a central display part 170, a sound part 140, a timer 130, a jackpot display part 150, and a jackpot game part 160, to increase interest in the game.

The central display part 170 is a reel display part that spins and stops simultaneously with the reel display parts 123 for individual players, and it is displayed at the center of the monitor to enable all the players to simultaneously check the start of the game and a game result.

Referring to FIGS. 4 and 12, the central display part 170 can not only be arranged on the same monitor with the reel display parts, but can be configured using a different monitor.

The sound part 140 is controlled to output some rhythmical music with the progress of the game. Also, the sound part 140 makes sound effect when a jackpot score is displayed or when a jackpot game or bonus game is played.

Additionally, to add visual effect, a lamp outputting various colors of light can be installed and operated.

The timer 130 is associated with the central display part 170 and operates with an individual timer 124. The timer 130 displays a remaining betting time or the progress of the remaining betting time as a graph.

The jackpot display part 150 displays a jackpot score when the game result of an individual reel game device 120 corresponds to the jackpot score.

In the configuration of the present invention, the jackpot display part is illustrated as a component separated from the control unit 110, but the jackpot display part 150 can be displayed on the individual reel display part 123 or the central display part 170.

Also, when the result of a game is set to lead to a jackpot game, the jackpot game is played by the jackpot game part 160.

As the display of the jackpot score, or the play and display of the jackpot game is common, the detailed description is omitted.

The above-described jackpot game part 150 can be run on the central display part 170 or the individual reel display parts 123, and the jackpot game can be played on a separate monitor.

The embodiment, in which the multi-reel game device configured as described above is implemented as a product, is illustrated in FIGS. 4 and 5.

FIG. 4 is a plan view of a multi-reel game device according to an embodiment of the present invention, and FIG. 5 is a front view of the multi-reel game device of FIG. 4. As illustrated in the drawings, the reel game device is for up to 6 players, and is configured to include: 6 individual reel game devices 120 disposed around the edges of a table 100; 6 reel display parts 123 for the individual players, arranged on a monitor 180, wherein each of the reel display parts 123 is displayed in a section of the monitor corresponding to the individual reel game devices 120; and a central display part 170 displayed at the center.

Also, a sound part 140, a money insertion detection unit 121, and a coin dispenser 190 are arranged for each player at the side of the table 100.

The coin dispenser 190 is configured to dispense multiple coins depending on the selection of the player when a game result satisfies a predetermined winning condition.

The control unit 110 receives an output signal from the money insertion detection unit 110 and the input unit 122, and controls the operations of the individual timer 124, the timer 130, the reel drive part 125, the winning score display part 126, the sound part 140, the jackpot display part 150, and the jackpot game part 160, while performing a reel game.

In other words, when individual players have completed a betting through the input unit 122, the control unit 110 simultaneously spins reels of the reel display parts 123 for the individual players; simultaneously stops them after a predetermined time has passed; allots a winning score according to a dividend rate when, among the symbols on the stopped reels of the reel display part 123, the betting line selected by the player includes the same symbols equal to or greater than a predetermined number; and displays the winning score on the winning score display part 126.

The control unit 110 can determine that the betting has been completed when all the betting amounts are selected through the selection button parts 122a of the input units 122 for the individual players, when all of the start buttons 122b are input, or when the betting time that is displayed on the individual timer 124 or on the timer 130 has finished. When the betting has been completed, the control unit 110 simultaneously drives the reel drive parts 125 for the individual players to spin the reels of the reel display parts 123.

In this case, it is desirable that the control unit 110 drives only the reel drive parts of the players that participate in the game, but it is possible to operate the reel display parts that are not participating in the game, for visual effect or to entice the participation in the game.

Then, the control unit 110 simultaneously stops spinning of the reels after a predetermined time has passed, and determines whether a winning score is obtained for each player.

In other words, when it is determined that the betting line selected by a player includes three or more of the same symbols, a winning score according to a dividend rate is respectively displayed on the winning score display part 126. In the stopped reel symbols of the reel display part 123, when the betting line selected by a player includes one or more Joker symbols, the Joker symbol is displayed or the Joker symbol is replaced with another symbol to raise the winning score of the corresponding line, and the winning score according to the dividend rate is displayed on the winning score display part 126 and is allotted.

On the other hand, it is desirable that the control unit 110 determines that all the players whose scores are accumulated in credit are participating in the game.

In this case, the player who has a score in credit but has not bet within the betting time is considered as a player who has no intention to participate in the game, thus only the reel display parts of the players participating in the game can be operated.

Also, when the stopped reel symbols on the reel display part 123 are the same as the symbols that are set to lead to a bonus game or a jackpot and when the betting line selected by the player includes three or more of the same symbols, the control unit 110 can play a bonus game and allot a bonus score, can display a jackpot score and allot the jackpot score, or can play a jackpot game.

An administrator or a player can select one among the play of the bonus game, the allotment of the jackpot score, or the play of the jackpot game.

The play of the bonus game and the bonus score are displayed on the individual reel display part 123, and the jackpot score and the play of the jackpot game can be also displayed on the individual reel display parts 123, but they are desirably displayed on the central display part 170 to be shared by the players.

In this case, when the jackpot game is played, the control unit 110 lights or blinks the jackpot display part 150 or makes sound effect through the sound part 140 in order to notify the players of the winning or the start of the jackpot game.

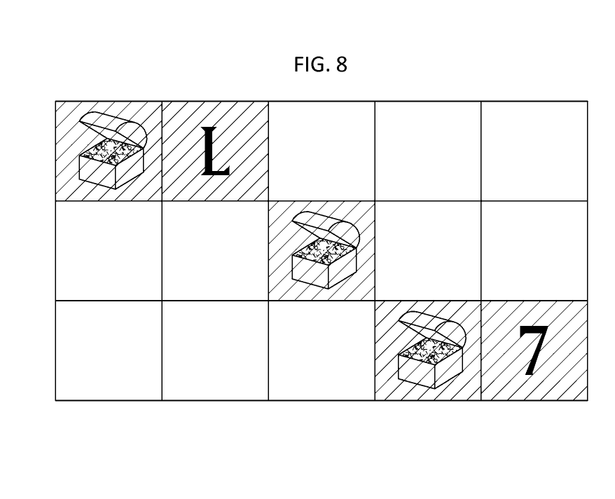

For example, in FIG. 8, referring to a view illustrating an example in which a player selects LINE 7 among the 25 lines and wins, the 3 jewel box symbols are included in the line.

Also, when two jewel boxes and one Joker are displayed in the selected line, the control unit 110 changes the Joker symbol to the jewel box to allow the player to get a higher score.

In the embodiment, the Joker is changed to the jewel box, but the control unit 11 may maintain the Joker symbol on the reel display part and just raise the score, when the Joker is included in the line.

The Joker symbol serves to raise the winning score, but the symbol can be changed to lead to a bonus game or a jackpot game.

In the above description, when a game is started, the reel display parts are simultaneously driven and stopped, and the reel display parts 123 for individual players and the central display part 170 display the same reel symbols. However, the reel game devices can be separately operated to enable individual players to enjoy different reel games.

In other words, using the multi-reel game device of the present invention, several players can play different reel games on a table.

To implement this, the control unit 110 differently drives an individual reel drive part 125 of each of the reel game devices 120 to enable each player to enjoy his or her own independent game.

As only the operation of the reel game device and the game result are differently driven and other functions and operations are the same as the concurrent control reel game device according to the above-described embodiment, the detailed description is omitted.

Hereinafter, with reference to the drawing, another embodiment of the present invention is described.

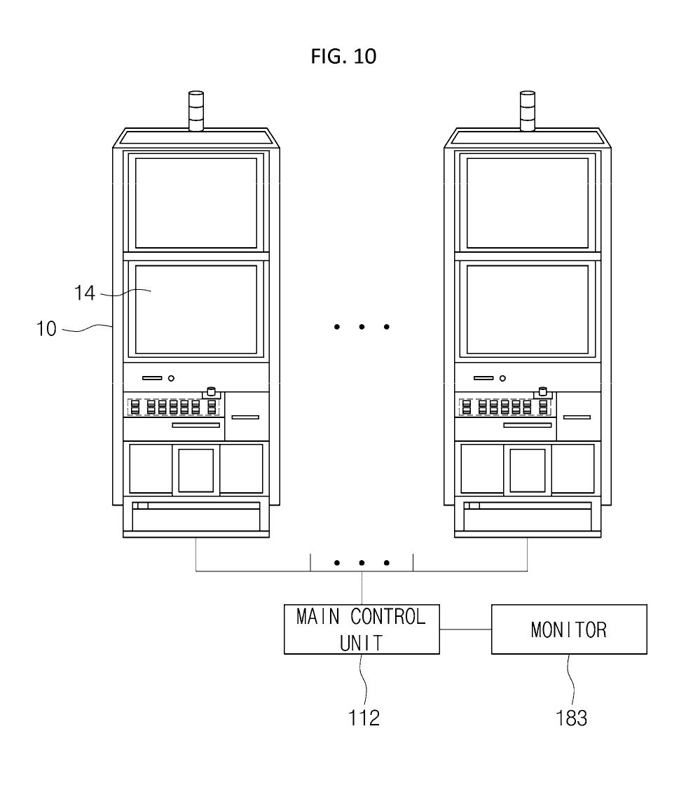

FIG. 10 is a main configuration diagram of a multi-reel game device according to another embodiment of the present invention. As illustrated in the drawing, the multi-reel game device of the present invention includes: three or more single-reel game devices 10 according to the existing configuration, each of the single-reel game device being individually operated; an individual control unit configured in the single-reel game devices 10 and a main control unit 112 for controlling the operations of the individual control units, which are connected by a network; and a billboard-type monitor 183 for displaying a result of the game.

The single-reel game device 10 has a monitor on which a reel display part 14 is arranged. Three or more reel rows and columns are displayed on the reel display part 14, and each reel has a reel symbol. One or more betting lines are set, wherein the betting line includes reels selected from each column displayed on the reel display part. A game is allowed to be played by betting the betting amount on the selected betting line.

To implement the above description, the single-reel game device 10 may include a money insertion detection unit for detecting insertion of money, and an input unit that contains: a selection button part for selecting a betting line or the betting amount; a game start button; a line display part for displaying the number of lines selected by a player; a betting display part; a credit display part; and a coin or ticket dispenser button.

Also, further included are a control unit for controlling the system, a reel drive part for driving the reel display part, and a winning score display part for displaying a winning score according to the drive of the reel.

As the above-described configuration is common, the repeated description is omitted.

The main control unit 112 connects three or more single-reel game devices by a network to communicate each other while the game is being played.

More specifically, the main control unit 112 is connected with the individual control unit of each of the single-reel game devices 10. When the betting amount has been selected, when the start button has been operated, or when the betting time has finished, the main control unit 112 simultaneously spins the reel of the reel display parts; simultaneously stops the reels after a predetermined time has passed; and allots a winning score according to a dividend rate when among the stopped reel symbols of the reel display part, the betting line selected by the player includes the same symbols equal to or greater than a predetermined number.

Also, the monitor 183 is configured as a billboard-type monitor, electrically connected with the main control unit 112, and the main control unit 112 displays the remaining betting time or the progress of the remaining betting time as a graph on the reel display part of the single-reel game device 10 or on the billboard monitor 183.

Additionally, among the players who participate in the game, the main control unit 112 separately displays people on the waiting list and people who have finished their betting on the monitor of the single-reel game device 10 or on the billboard monitor 183.

Hereinafter, a method of controlling the multi-reel game device according to an embodiment of the present invention is described referring to the drawings.

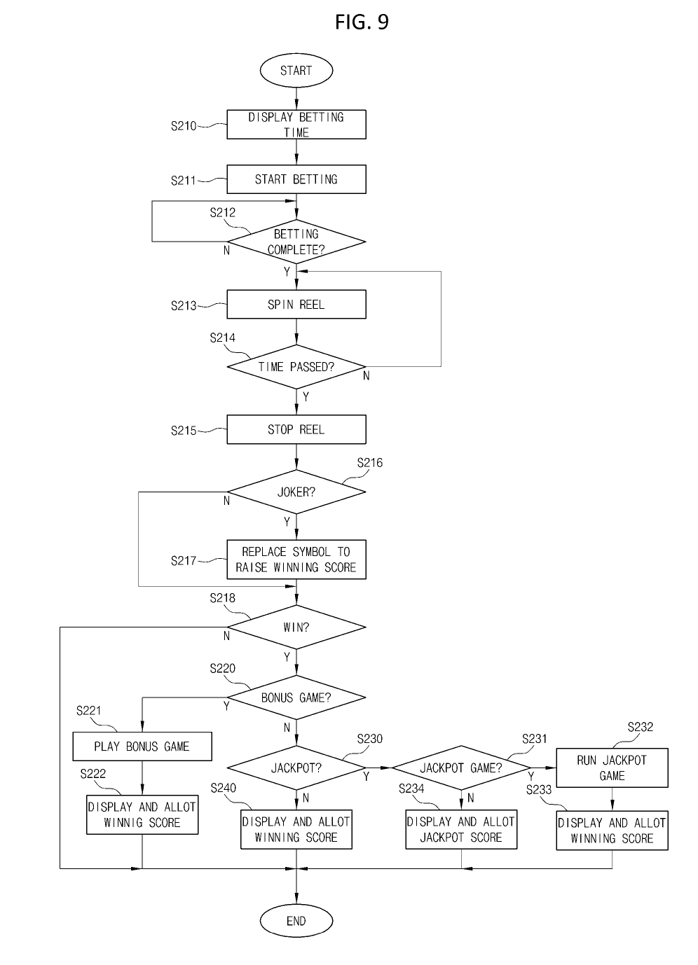

FIG. 9 is a flow diagram for illustrating a method of controlling the multi-reel game device according to an embodiment of the present invention. As illustrated in the drawing, a method of controlling the device, in which reel display parts 123 are arranged for three or more players on a table 100 and each of the reel display part 123 is configured as an array with three or more rows and columns of reels that have one or more symbols, performs the following processes: displaying a betting time on an individual timer 124 or a timer 130 at step S210; selecting, by each player, a betting line through an input unit 122 and selecting the betting amount on the selected betting line at step S211; determining by a control unit 110, whether the betting has been completed at step S212; spinning the reels of the reel display parts 123 at the same time at step S213 when it is determined that the betting has been completed at step S212; and stops the reels of the reel display part 123 after a predetermined time has passed at steps S214 to S215.

After the reels stop at step S215, among the symbols displayed on the stopped reels of the reel display part 123, if the number of the same symbols that are included in the betting line selected by a player is equal to or greater than a predetermined number (3 in the present embodiment) at step S216, the control unit 110 performs steps for allotting a winning score for each player according to a dividend rate at steps S220 to S243.

More specifically, at step S210, when the control unit 110 determines through the money insertion detection unit 110 that credit is inserted, the control unit 110 can display a betting time.

In this case, the control unit 110 displays the remaining betting time or the progress of the remaining betting time as a graph in the individual timer 124 or in the central timer 170, to visually check the betting progress status.

Also, among players participating in a game, people on the waiting list and people who have finished betting within the betting time are separately displayed on one or more of the reel display parts 123, to check the betting progress status.

Then, at step S211, it is determined whether each player has selected a betting line through the input unit 122, and the selected betting line is displayed on the selected line display part 122c, which is arranged on the relevant reel display part 123 or in the input unit 122, to easily check the selected betting line.

One or more betting lines can be individually selected among the 25 predetermined betting lines, but using the line selection (Line [symbol] , Line [symbol] ) buttons of the selection button part 122a, a bundle of 3 lines, 5 lines, 9 lines, or 25 lines can be selected at once.

Also, at step S211, after the betting line is selected, the betting amount is bet on the betting line.

The betting amount is selected using the betting amount selection button (Bet 1 to Bet 30). Accordingly, when the betting amount selection button is pressed, the betting amount corresponding to credit displayed on the button is selected.

At step S212, it is determined whether the betting has been completed by each player, through the input unit 122. The completion of the betting is determined when all the players have selected the betting amount through the selection button part 122a of the input unit 122 for each player, as described above, when all the players participating in the game have input the start (Spin) button 122b, or when the betting time displayed in the individual timer 124 or the central timer 130 has finished.

When it is determined that the betting has been completed at step S212, the control unit 110 simultaneously outputs control signals for driving the reel drive parts 125 of the individual reel game devices 120, so as to spin the reels of the reel display parts 123 for individual players at step S213.

When the reels of the individual reel game devices 120 spin at step S213, the control unit 110 determines whether a predetermined time has passed at step S214. When the predetermined time has passed at step S214, the control unit 110 transmits control signals for simultaneously stopping the reels of the individual reel game devices to the reel drive parts 125 of the individual reel game devices 120 at step S215 in order that the stopped reels have the same symbols.

In this case, the game result can be displayed in the individual reel display parts 123 or in the central display part 170.

At step S215, after the reels of the individual reel game devices 120 stop, the control unit 110 displays a Joker symbol or replaces the Joker symbol according to whether the Joker symbol exists on the stopped reels. Then, depending on the winning result, the control unit 110 controls a system to play a bonus game at steps S221 to S222, to allot a winning score at step S240, to display and allot a jackpot score at step S234 when the jackpot is won, or to play a jackpot game at step S232 to S233.

On the other hand, at steps S213 to S215, the case in which before and after the game, reels on the reel display parts 123 or the reels on the central display part 170 are identically displayed is described. However, it is possible to enjoy different reel games using the multi-reel game device of the present invention.

For example, a button for selecting a single game, which can be separately run, is added to the multi-reel game device of the present invention, and when a player presses the single game selection button, the individual reel game devices 120 can be differently operated though multiple players play the games on a single table.

Also, the multi-reel game device can be configured to be operated as interconnected reel game devices or as individual game devices according to the selection of an administrator.

Additionally, when multiple single-game devices are separately installed, there exist spatial constraints. Therefore, multiple single-game devices may be installed on a table during the manufacturing process.

More specifically, after the reels stop at step S215, the control unit 110 determines whether a Joker is included in the betting lines selected by each player at step S216.

As a Joker is intended for increasing the interest of a game and for raising a winning probability of a player, it is optionally applied.

In other words, among symbols on the stopped reels of the reel display part 123, when one or more Joker symbols are included in the betting line selected by a player at step S216, the Joker symbol is replaced with another symbol to raise a winning score of the selected line at step S217.

In this case, the control unit 110 can maintain the Joker symbol and just raise the winning score.

In the embodiment of the present invention, when three or more the same symbols are included in the betting line, the winning is determined. Also, when a bonus symbol or a jackpot symbol is obtained, a bonus game or a jackpot game is played. Therefore, when the Joker symbol is included, the control unit 110 determines whether a jackpot is possible, and then replaces the Joker symbol with another symbol, firstly to play the bonus game, otherwise to raise the winning score.

In this case, the control unit 110 can maintain the Joker symbol without replacement, and just can check the possibility of jackpot, play the bonus game, or raise the winning score.

When the Joker symbol is replaced with another symbol at step S217, or when it is determined at step S216 that the selected betting line does not include the Joker symbol, the control unit 110 determines whether the betting line selected by a player includes three or more the same symbols at step S218.

When it is determined at step S218 that the game is not won, the control unit 110 terminates the game or plays the next game, whereas when it is determined at step S218 that the game is won, the control unit 110 determines whether a bonus game is won at step S220.

As described above, when the symbols on the stopped reels of the reel display part are the same as the symbols that are set to lead to a bonus game, the bonus game is played.

When a condition for the bonus game is satisfied at step S220, the bonus game is played at step S221. Then, as the result of the bonus game, a winning score is displayed and allotted.

As the results of the games can be differently displayed for the individual players, the bonus game is played desirably in the individual reel display parts 123.

On the other hand, when the condition for the bonus game is not satisfied at step S220, a jackpot condition is checked at step S230.

When symbols on the stopped reels of the reel display part are the same as the symbols that are set to lead to a jackpot and when the betting line selected by a player includes three or more the same symbols, the jackpot progresses.

When the condition for the jackpot is not satisfied at step S230, a winning score is displayed by calculating the score bet by the player, and the winning score is allotted at step S240.

In this case, the winning scores for individual players are respectively displayed on the reel display parts 123.

When the condition for the jackpot is satisfied at step S230, it is determined at step S231 that either a jackpot score is displayed and allotted or a jackpot game is played, according to the set condition.

If the system is set to allot the jackpot score at step S231, the jackpot score is displayed and allotted at step S234.

In this case, the jackpot score is displayed in the individual reel display parts 123 or in the central display part 170 to enable players participating in the game to check whether the jackpot is won.

Also, when the system is set to lead to the jackpot game at step S231, the control unit 110 drives the jackpot game in the central display unit 170 or in the individual reel display parts 123, displays a winning score as the result of the game, and allots the winning score at steps S232 to S233.

In the above description, the method of controlling the multi-reel game device, in which reel display parts 123 are arranged for three or more players on a table 100 and the players can enjoy a game at the same time using the reel display part 123 assigned to each of the players, is illustrated. However, in the case of a multi-reel game device including: three or more single-reel game devices 10 having a reel display part; a main control unit 112, which is connected with the single-reel game devices 10 by a network for communication and control; and a billboard monitor 183, which electrically connected with the main control, the same method can be used for controlling the game.

For example, in FIG. 9, referring to a flow diagram illustrating a method of controlling a multi-reel game device according to an embodiment of the present invention, a betting time is displayed in the single-reel game devices or on the billboard monitor at step S210; a betting line is selected for single-reel game devices 10 each and the betting amount is selected for the betting line at step S211; the main control unit 112 controls the reels of the single-game devices to be spun at the same time at step S213 when the betting amount has been selected in single-reel game devices 10, when the start button has been operated, or when the betting time has finished; and the main control unit 112 simultaneously stops the reel display parts 14 at step 215 after a predetermined time has passed at step S214.

More specifically, after the reels stop at step S215, the control unit 110 determines at step S216 whether a betting line selected by a player includes a Joker. At step S216, when, among symbols on the stopped reels of the reel display part 14, one or more Jokers are included in the betting line selected by the player, the Joker symbol is maintained or replaced with another symbol at step S217 to raise a winning score for the betting line.

When a Joker is replaced with another symbol at step 217, or when the selected betting line does not include the Joker symbol at step S216, the control unit 110 determines whether the selected betting line includes three or more the same symbols at step S218.

When it is determined that the game is not won at step S218, the control unit 110 terminates the game or plays the next game, whereas, when it is determined that the game is won at step S218, the control unit 110 determines whether a bonus game is won at step S220.

When a condition for the bonus game is satisfied at step S220, the bonus game is played at step S221; a score of the bonus game is displayed; and the score is allotted.

Desirably, as the game results can be differently displayed between the players, the bonus game is played in the individual reel display parts 14.

On the other hand, when the condition for the bonus game is not satisfied at step S220, it is determined whether a jackpot condition is satisfied at step S230.

When symbols on the stopped reels of the reel display parts are the same as symbols that are set to lead to a jackpot, and when the betting line selected by a player includes three or more the same symbols, the jackpot progresses.

When a condition for the jackpot is not satisfied at step S230, a winning score is obtained by calculating the score bet by the player, and the winning score is displayed and allotted at step S240.

In this case, the winning scores for the individual players are displayed in the reel display parts 123 of the individual players and in the billboard monitor 183

When the condition for the jackpot is satisfied at step S230, it is determined at step S231 that either a jackpot score is displayed and allotted or a jackpot game is played, according to the set condition.

If the system is set to allot a jackpot score at step S231, the jackpot score is displayed and allotted at step S234.

In this case, the jackpot score is displayed in the billboard monitor 183 to enable players participating in the game to check whether the jackpot is won.

Also, when the system is set to lead to the jackpot game at step S231, the control unit 110 drives the jackpot game in the billboard monitor 183 or in the reel display parts 14, displays a winning score as the result of the game, and allots the winning score at steps S232 to S233.

On the other hand, using the multi-reel game device of the present invention, an individual reel game method, rather than the interconnected method, can be also performed (with reference to FIG. 12).

In other words, in the case of a multi-reel game device in which a central monitor 181 disposed at the center and monitors for one or more players are arranged, the monitors for individual players having reel display parts 182a to 182d formed as an array of three or more rows and columns, the game can be controlled using the same method.

For example, in FIG. 9, referring to a flow diagram illustrating a method for controlling a multi-reel game device according to an embodiment of the present invention, each player selects a betting line through an input unit, and performs a betting step to select the betting amount for the betting line at steps S210 to S211.

In this case, as individual players play the different games, the reel display parts 182a to 182d or the input unit 122 of the individual reel game devices can display a betting time.

When it is determined that the players have completed their betting at step S212, the control unit 110 spins the reels of the reel display parts of the players who have completed the betting and stops the reels of the reel display part after a predetermined time has passed at steps S214 to S215.

More specifically, after the reel stops at step S215, the control unit 110 determines at step S216 whether the betting line selected by each player includes a Joker. When, among symbols on the stopped reel of each of the reel display parts 182a to 182d, the betting line selected by a player includes one or more Jokers, the Joker symbol is maintained or replaced with another symbol to raise a winning score of the selected betting line at step S217.

When the Joker symbol is replaced with another symbol at step S217, or when it is determined at step S216 that the selected betting line does not include a Joker, the control unit 110 determines whether the betting line selected by the player includes three or more the same symbols at step S218.

When it is determined that the game is not won at step S218, the control unit 110 terminates the game or plays the next game, whereas when it is determined that the game is won at step S218, it is determined at step S220 whether a bonus game is won.

When a condition for the bonus game is satisfied at step S220, the bonus game is played at step S221, a winning score of the game is displayed, and the winning score is allotted.

Desirably, as the results of the game can be differently displayed for the individual players, the bonus game is respectively played in the individual reel display parts 182a to 182d.

On the other hand, when the condition for the bonus game is not satisfied at step S220, it is determined whether a jackpot condition is satisfied at step S230.

When symbols on the stopped reel of the reel display parts are the same as symbols that are set to lead to a jackpot, and when the betting line selected by the player includes three or more the same symbols, the jackpot progresses.

When the condition for the jackpot is not satisfied at step S230, a winning score is obtained by calculating the score bet by the player and the winning score is displayed and allotted at step S240.

In this case, the winning scores for individual players are displayed in the reel display parts 182a to 182d of the players and in the central monitor 181.

When the condition for the jackpot is satisfied at step S230, it is determined at step S231 that either a jackpot score is displayed and allotted or a jackpot game is played, according to the set condition.

If the system is set to allot a jackpot score at step S231, the jackpot score is displayed and allotted also at step S234.

In this case, the jackpot score is displayed in the central display part 181 to enable players participating in the game to check whether the jackpot is won.

Also, when the system is set to lead to the jackpot game at step S231, the control unit 110 drives the jackpot game in the central monitor 170 or in the reel display parts 182a to 182d, displays a winning score as the result of the game, and allots the winning score at steps S232 to S233.

As described above, the present invention provides three or more reel display parts displayed at the center and around the edges of a monitor on a table so that a game can be played by interconnecting the reel display parts or players each can enjoy his or her own reel game. Accordingly, multiple players enjoy a group game, and at the same time, multiple players each can independently enjoy his or her game on a table, thus improving space occupancy.

Also, the present invention arranges three or more monitors having a reel display part on a table to enable to enjoy a game by interconnecting the monitors, or to allow an individual game.

Additionally, the present invention interconnects separately installed single-reel game devices by a network, to enjoy a multiplayer game or to enjoy separate independent games.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

The present invention enables several people to enjoy a reel game device at the same time in a game room.

1. A multi-reel game device, which has reel display parts for three or more players at a table, determines one or more betting lines, and enables the players to simultaneously play a game using the reel display parts assigned to the individual players, wherein the reel display parts each have reels that are formed as an array with three or more rows and columns, the reels each have one or more symbols, and the betting line includes each column of the reels to be displayed on the reel display part,
the multi-reel game device, comprising:
a control unit, which simultaneously spins the reels of the reel display parts when the players have selected a betting amount, when a start button has been operated, or when a betting time has finished; simultaneously stops the reels after a predetermined time has passed; and allots a winning score according to a dividend rate when, among symbols of the stopped reels of the reel display part, the same symbols included in a betting line that a relevant player has selected are equal to or greater than a predetermined number.

2. The multi-reel game device of claim 1, wherein the reel display parts for the individual players are simultaneously displayed on a monitor.

3. The multi-reel game device of claim 2, wherein, around edges of the monitor, three or more reel display parts are assigned to players, respectively.

4. The multi-reel game device of claim 3, wherein, in each of the reel display parts around the edges, an input unit for selecting a betting line and a betting amount are assigned.

5. The multi-reel game device of claim 4, wherein one or more of the reel display parts include a timer that displays a remaining betting time or a progress of the remaining betting time, as a graph.

6. The multi-reel game device of claim 4, wherein the reel display parts separately display people on a betting waiting list and people who have finished betting within the betting time, among players participating in the game.

7. The multi-reel game device of claim 3, wherein the control unit displays the winning score for each of the players on the reel display parts.

8. The multi-reel game device of claim 1, wherein the reel display parts are displayed on a central monitor disposed at the center and on additional monitors for the individual players.

9. The multi-reel game device of claim 8, wherein the monitors for the individual players each have an input unit that has one or more keys for selecting the betting line and the betting amount.

10. The multi-reel game device of claim 9, wherein one or more of the reel display parts include a timer that displays a remaining betting time or a progress of the remaining betting time, as a graph.

11. The multi-reel game device of claim 10, wherein any one of the reel display parts separately display people on a betting waiting list and people who have finished betting within the betting time among players participating in the game.

12. The multi-reel game device of claim 8, wherein the control unit displays the winning score on the reel display parts for the individual players.

13. The multi-reel game device of claim 1, further comprising:
a timer for displaying a betting time; and
start buttons, for enabling each of the players to start a game,
wherein the control unit determines that the players have completed the betting when the betting time of the timer has finished, when the players have completed their betting within the betting time of the timer, or when the players have input the start buttons.

14. A multi-reel game device, comprising:
a single-reel game device, which displays three or more rows of reels and three or more columns of reels, determines one or more betting lines, and allows a game by betting a betting amount for the selected betting line, wherein each of the reels has a reel symbol and the betting line includes each column of the reels displayed on the reel display part; and
a main control unit, which connects three or more of the single-reel game devices by a network, for allowing playing a game while communicating with the devices,
wherein the main control unit simultaneously spins the reels of the single-reel game devices when a betting amount of the single-reel game devices has been selected, when start button has been operated, or when a betting time has finished; simultaneously stops the reels after a predetermined time has passed; and allots a winning score according to a dividend rate when, among symbols of the stopped reels of the reel display part, the same symbols included in a betting line that a relevant player has selected are equal to or greater than a predetermined number.

15. The multi-reel game device of claim 14, further comprising, a billboard monitor that is electrically connected with the main control unit,
wherein the main control unit displays a remaining betting time or a progress of the remaining betting time, as a graph on monitors of the single-reel game devices or on the billboard monitor.

16. The multi-reel game device of claim 15, wherein on the monitors of the single-reel game devices or on the billboard monitor, the main control unit separately displays people on a betting waiting list and people who have finished betting within the betting time, among players participating in the game.

17. A method of controlling a multi-reel game device that has reel display parts for three or more players at a table, determines one or more betting lines, and enables the players to simultaneously play a game using the reel display parts assigned to the individual players, wherein the reel display parts each have reels that are formed as an array with three or more rows and columns, the reels each have one or more symbols, and the betting line includes each column of the reels to be displayed on the reel display part,
the method of controlling the multi-reel game device, comprising:
(a) displaying a betting time in a timer;
(b) a betting step, by each of the players, for selecting a betting line through an input unit, and for selecting a betting amount for the betting line;
(c) simultaneously spinning, by a control unit, the reels of the reel display parts when the betting step has been completed within the betting time of the timer, and simultaneously stopping, by the control unit, the reels of the reel display parts after a predetermined time has passed;
(d) determining whether among symbols of the stopped reels of the reel display part, the same symbols included in the betting line that a relevant player has selected are equal to or greater than a predetermined number; and
(e) allotting, by the control unit, a winning score for each of the players according to a dividend rate when it is determined at step (d) that the same symbols included in the betting line are equal to or greater than the predetermined number.

18. The method of claim 17, wherein step (a) further comprises,
displaying a remaining betting time or a progress of the remaining betting time, as a graph in one or more of the reel display parts.

19. The method of claim 17, wherein step (a) further comprises,
separately displaying people on a betting waiting list and people who have finished betting within the betting time, among players participating in the game, in one or more of the reel display parts.

20. The method of claim 17, wherein step (e) displays the winning score for each of the players on the reel display part of each of the players.

21. The method of claim 17, wherein step (b) comprises:
(b-1) selecting, by each of the players, a betting line through an input unit;
(b-2) displaying the selected betting line on the relevant reel display part or a display part disposed in the input unit; and
(b-3) selecting a betting amount for the betting line and displaying the betting amount.

22. The method of claim 21, wherein step (c) comprises:
(c-1) determining by the control unit, that any one is satisfied among whether the betting time of the timer has finished, whether all the players participating in the game have selected the betting line and the betting amount, or whether the start button has been operated;
(c-2) simultaneously spinning the reels of the reel display parts when any one is satisfied at step (c-1); and
(c-3) simultaneously stopping, by the control unit, the spinning reel display parts after a predetermined time has passed.

23. The method of claim 22, wherein step (c-2) simultaneously spins the reels of the reel display parts immediately when all the players participating in the game have completed their betting at step (c-1).

24. The method of claim 17, wherein step (e) comprises:
(e-1) allotting a winning score according to a dividend rate when among symbols of the stopped reels of each of the reel display parts, three or more of the same symbols are included in the betting line that the relevant player has selected;
(e-2) displaying a Joker symbol or changing the Joker symbol to raise a winning score of the betting line, and allotting the winning score according to the corresponding dividend rate, when among the symbols of the stopped reels of each of the reel display parts, one or more of the Joker symbols are included in the betting line selected by the relevant player; and
(e-3) performing any one selected from among the play of a bonus game, the play of a jackpot game, or the allotment of a jackpot score when the betting line selected by the relevant player includes three or more of the same symbols and when the symbols of the stopped reels of each of the reel display parts are the same as the symbols set to lead to the bonus game, set to lead to the jackpot game, or set to allot the jackpot score.

25. A method of controlling a multi-reel device that has a single-reel game device, a main control unit that connects three or more of the single-reel game devices by a network for allowing playing a game while communicating with the single-reel game devices, and a billboard monitor that is electrically connected with the main control device, wherein the single-reel game device has a reel display part formed as an array with three or more rows and columns, determines one or more betting lines, and allows playing a game by betting a betting amount for the selected line, the reels each having one or more symbols, and the betting line including each column of the reels to be displayed on the reel display part,
the method comprising:
(a) displaying a betting time in the single-reel game device or on the billboard monitor;
(b) selecting a betting line in each of the single-reel game devices, and selecting a betting amount for the betting line;
(c) simultaneously spinning, by the main control unit, the reels of the single-reel game devices when the betting amount has been selected by the single-reel game devices, when a start button has been operated, or when a betting time has finished; and simultaneously stopping, by the main control unit, the reel display parts after a predetermined time has passed;
(d) determining whether among symbols of the stopped reels of each of the reel display part, the same symbols included in the betting line that a relevant player has selected are equal to or greater than a predetermined number; and
(e) allotting, by an individual reel control unit, a winning score according to a dividend rate when the same symbols included in the betting line are equal to or greater than the predetermined number at step (d).

26. The method of claim 25, wherein step (a) further comprises,
displaying a remaining betting time or a progress of the remaining betting time, as a graph.

27. The method of claim 25, wherein step (a) further comprises,
separately displaying people on a betting waiting list and people who have finished betting within the betting time, among players participating in the game.

28. The method of claim 25, wherein step (e) displays the winning score in the reel display part or on the billboard monitor.

29. The method of claim 25, wherein step (c) comprises:
(c-1) determining by the main control unit, that any one is satisfied among whether the betting time has finished, whether all the players participating in the game have selected the betting line and the betting amount, or whether the start button has been operated;
(c-2) simultaneously spinning reels of the reel display parts when any one is satisfied at step (c-1); and
(c-3) simultaneously stopping, by the main control unit, the spinning reel display parts after a predetermined time has passed.

30. The method of claim 29, wherein step (c-2) simultaneously spins the reels of the reel display parts immediately when all the players participating in the game have completed their betting at step (c-1).

31. The method of claim 26, wherein step (e) comprises:
(e-1) allotting a winning score according to a dividend rate when among symbols of the stopped reels of each of the reel display parts, three or more of the same symbols are included in the betting line selected by the relevant player;
(e-2) displaying a Joker symbol or changing the Joker symbol to raise a winning score of the betting line, and allotting the winning score according to the corresponding dividend rate, when among the symbols of the stopped reels of each of the reel display parts, one or more of the Joker symbols are included in the betting line selected by the relevant player; and
(e-3) performing any one selected from among the play of a bonus game, the play of a jackpot game, or the allotment of a jackpot score when the betting line selected by the relevant player includes three or more of the same symbols and when the symbols of the stopped reels of each of the reel display parts are the same as the symbols set to lead to the bonus game, set to lead to the jackpot game, or set to allot the jackpot score.

32. A multi-reel game device, which separately arranges reel display parts that have reels formed as an array with three or more rows and columns, for three or more players on one monitor on a table; arranges a jackpot display part on one side of the table; and enables each of the players to play an individual game by selecting one or more lines among predetermined betting lines that include each column of the reels displayed on each of the reel display parts, the reels each having one or more symbols,
the multi-reel game device, comprising:
a control unit, which spins a reel display part either when the predetermined betting line and betting amount are selected in the corresponding reel display part or when a start button has been operated; stops the reel display part after a predetermined time has passed; and allots a winning score according to a dividend rate when among symbols of the stopped reels of the reel display part, the same symbols included in the betting line that a relevant player has selected are equal to or greater than a predetermined number.

33. The multi-reel game device of claim 32, wherein the control unit allots a bonus score or allows playing a bonus game when the symbols of the stopped reels of the reel display part are the same as symbols set to lead to the bonus game and when the betting line selected by the relevant player includes three or more of the same symbols.

34. The multi-reel game device of claim 33, wherein the bonus game controlled by the control unit is played in the corresponding reel display part or in the jackpot display part.

35. The multi-reel game device of claim 32, wherein the control unit determines and displays one or more symbols for a jackpot score in the jackpot display part; and allots a score displayed in the jackpot display part, allots a jackpot score as the result of the winning of the jackpot game, or allots an additional score according to the jackpot game when the symbols of the stopped reels of the reel display part are the same as the symbols set to lead to the jackpot and when the betting line selected by the relevant player includes three or more of the corresponding symbols.

36. The multi-reel game device of claim 35, wherein the control unit notifies of the entry of the jackpot game or winning of the jackpot game by lighting or blinking the jackpot display part or by using a sound effect.

37. The multi-reel game device of claim 35, wherein the control unit displays a Joker symbol or changes the Joker symbol to raise a winning score of the betting line, and allots the winning score according to the corresponding dividend rate when among the symbols of the stopped reels of the reel display part, one or more the Joker symbols are included in the betting line selected by the relevant player.

38. The multi-reel game device of claim 32, wherein each of the reel display parts has an input unit in which one or more keys for selecting the betting line and the betting amount are arranged.

39. The multi-reel game device of claim 32, wherein the control unit displays the winning score in the corresponding reel display part.

40. A multi-reel game device, which has reel display parts for three or more players on a table, determines one or more betting lines, and enables the players to simultaneously play a game using the reel display parts assigned to the individual players, wherein the reel display parts each have reels that are formed as an array with three or more rows and columns, the reels each have one or more symbols, and the betting line includes each column of the reels to be displayed on the reel display part,
the multi-reel game device, comprising:
a single game selection button, arranged in each of the reel display parts; and
a control unit, which simultaneously spins the reels of the reel display parts except for the reel display parts in which the single game selection button is input, when the players have selected a betting amount, when a start button has been operated, or when a betting time has finished; simultaneously stops the reels after a predetermined time has passed; and allots a winning score according to a dividend rate when among symbols of the stopped reels of the reel display part, the same symbols included in the betting line that a relevant player has selected are equal to or greater than a predetermined number.

41. The multi-reel game device of claim 40, further comprising,
an input unit, for selecting a betting amount assigned in each of the reel display parts, and for selecting a betting line in each of the reel display parts,
wherein the control unit spins the reels of the reel display part in which the single game button is input, when the betting amount has been selected in the corresponding reel display part, when the start button has been operated, or when a betting time has finished; stops the reels after a predetermined time has passed; and allots a winning score according to a dividend rate when among symbols of the stopped reels of the reel display part, the same symbols included in the betting line that a relevant player has selected are equal to or greater than a predetermined number.

42. The multi-reel game device of claim 41, wherein the reel display parts for the individual players are simultaneously displayed on a monitor, and three or more of the reel display parts are arranged for the players, respectively, around the edges of the monitor.

43. The multi-reel game device of claim 40, wherein the reel display parts are displayed on a central monitor disposed at the center and on additional monitors for individual players.

44. A multi-reel game device, which has reel display parts for three or more players on a table, determines one or more betting lines, and enables the players to play a game using the reel display parts assigned to the individual players, wherein the reel display parts each have reels that are formed as an array with three or more rows and columns, the reels each have one or more symbols, and the betting line includes each column of the reels to be displayed on the reel display part,
the multi-reel game device, comprising:
an input unit, arranged in each of the reel display parts, for selecting a betting amount and the betting line; and
a control unit, which spins the reels of the reel display parts assigned to the individual players when the players have selected a betting amount, when a start button has been operated, or when a betting time has finished; stops the reels after a predetermined time has passed; and allots a winning score according to a dividend rate when among symbols of the stopped reels of the reel display part, the same symbols included in a betting line that a relevant player has selected are equal to or greater than a predetermined number.

45. The multi-reel game device of claim 44, wherein the reel display parts are simultaneously displayed on a monitor, and three or more of the reel display parts are arranged for the players, respectively, around the edges of the monitor.

46. The multi-reel game device of claim 44, wherein the reel display parts are displayed on a central monitor disposed at the center and on additional monitors for the individual players.
